(19) United States
(12) Patent Application Publication
(10) Pub. No.: US 2012/0240449 A1
(43) Pub. Date: Sep. 27, 2012

(54) Sinker

(76) Inventor: Randy G. Phillips, Chino, CA (US)

(21) Appl. No.: 13/071,202

(22) Filed: Mar. 24, 2011

(51) Int. Cl. A01K 95/02

(52) U.S. Cl. 43/44.93

(57) ABSTRACT

The present invention is a sinker for fishing. The sinker preferably comprises an attachment cap with a perimeter groove, a cavity and an attachment post with a hole. The cap can be attached to a fishing line or swivel at the attachment post. The cap is insertable into a weighted body through a gasket that interfaces with the perimeter groove. The weighted body preferably has a dimpled cavity that aligns with the cavity of the cap when inserted. The gasket is preferably an O-ring made of natural or synthetic rubber. The cap preferably comprises anodized aluminum and the weighted body preferably comprises steel or stainless steel.

### TECHNICAL FIELD

The present invention is a sinker for fishing.

### BACKGROUND OF THE INVENTION

Fishermen often use sinkers or fishing weights to alter the overall buoyancy of their line, bait and/or lure. The weight then “sinks” the line, bait or lure so that it does not float on the surface. Prior art sinkers are typically tied to the fishing line or attached via a swivel. Thus, attaching the weight can be difficult or time consuming. Also, sinkers can become entangled with debris in bodies of water into which they are cast. Since such sinkers are often made of lead, losing these lead weights in the water can cause environmental issues. Thus, a sinker that is easier to attach to a fishing line and easier to release from an entangled line is desired.

### SUMMARY OF THE INVENTION

The present invention is a sinker for fishing. The sinker preferably comprises an attachment cap with a perimeter groove, a cavity and an attachment post with a hole. The cap can be attached to a fishing line or swivel at the attachment post. The cap is insertable into a weighted body through a gasket that interfaces with the perimeter groove. The weighted body preferably has a dimpled cavity that aligns with the cavity of the cap when inserted. The gasket is preferably an O-ring made of natural or synthetic rubber. The cap preferably comprises anodized aluminum and the weighted body preferably comprises steel or stainless steel.

### BRIEF DESCRIPTION OF THE SEVERAL VIEWS OF THE DRAWINGS

The present invention described herein will become apparent from the following detailed description considered in connection with the accompanying drawings, which disclose several embodiments of the invention. It should be understood, however, that the drawings are designed for the purpose of illustration and not as limits of the invention.

FIG. 1 is a perspective view of a preferred embodiment of the invention in separated position;

FIG. 2 is a side cut-away view of a preferred embodiment of the invention in separated position;

FIG. 3 is a side cut-away view of a preferred embodiment of the invention in joined position;

FIG. 4 is a side view of another preferred embodiment of the invention in separated position; and,

FIG. 5 is a side cut-away view of another preferred embodiment of the invention in separated position.

### DETAILED DESCRIPTION OF THE INVENTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

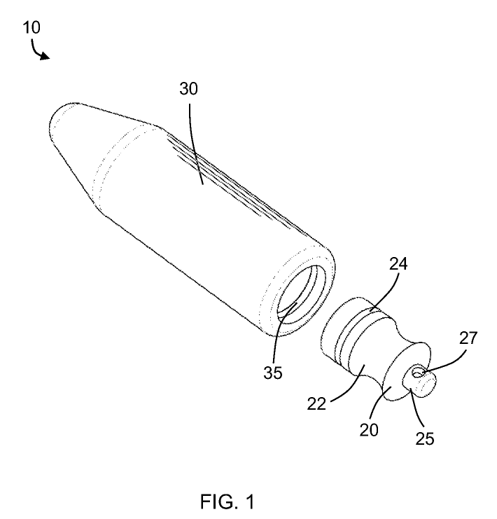

Referring now to FIG. 1, a preferred embodiment of the invention 10 is shown in a separated position. An attachment cap 20 is shown separated from a weighted body 30. The attachment cap 20 preferably has an attachment post 25 with a hole 27. The attachment post 25 and hole 27 are preferably used to secure the attachment cap 20 to a fishing line or swivel (not shown). The attachment cap 20 also preferably has an indented grip 22 and a perimeter groove 24. The cap 20 (male) is insertable into the weighted body 30 (female) through a gasket 35 inside the weighted body 30.

The weighted body 30 is preferably made of stainless steel or steel that is painted or powder coated. However, the body can be made of other non-buoyant material such as lead. The weighted body is preferably weighted to even increments such as a quarter ounce up to 32 ounces in weight. The gasket 35 shown in FIG. 1 is an O-ring. The O-ring 35 is preferably made of natural or synthetic (e.g. silicone) rubber. A preferred O-ring that can be used is a Buna 70. However, other materials such as various plastics can be used. The attachment cap 20 is preferably made of anodized aluminum to reduce its weight.

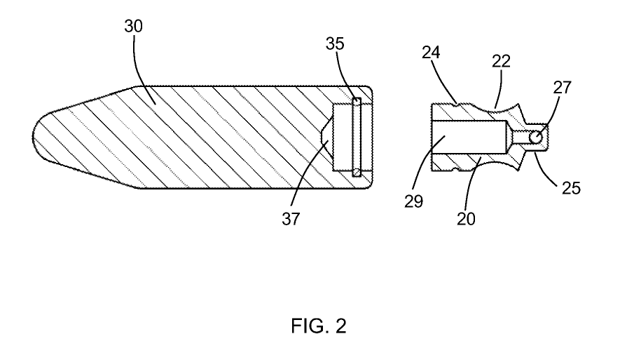

Referring now to FIG. 2, a cut-away side view of the preferred embodiment of the invention 10 is shown in a separated position. The attachment cap 20 preferably has an interior cavity 29. The cavity 29 is preferably used to reduce the weight of the cap 20 and to reduce any hydraulic pressure when inserted into the body 30. The weighted body 30 preferably has a dimpled cavity 37. The dimpled cavity 37 preferably provides an easier release of the cap 20.

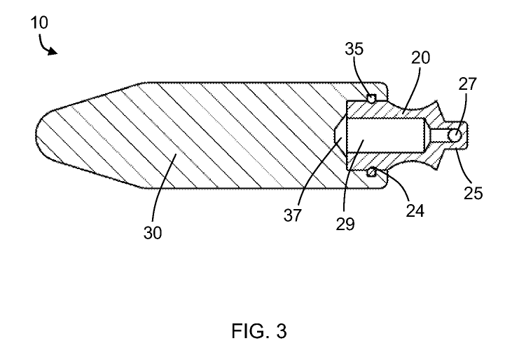

Referring now to FIG. 3, a cut-away side view of the preferred embodiment of the invention 10 is shown in a joined position. The attachment cap 20 is inserted into the weighted body 30. Preferably, the interior cavity 29 of the cap 20 aligns with the dimpled cavity 37 of the body 30. Also, the perimeter groove 24 of the cap 20 preferably interfaces with the O-ring 35 to hold the cap 20 in the body 30.

For usage, the cap 20 can be tied to a fishing line or attached to a swivel. When a user wishes to add weight to his or her line, the user chooses a weighted body 30 of a desired weight, e.g. 2 ounces and preferably pushes the cap 20 into the weighted body 30 until the perimeter groove 24 interfaces with the O-ring 35. The fit between the groove 24 and the O-ring 35 should be such that the body 30 will not separate from the cap 20 during casting and normal fishing activity. However, if the sinker 10 becomes caught in an inaccessible location such as a lake bottom, the user can tug the cap 20 free and separate the cap 20 and attached fishing line from the weighted body 30.

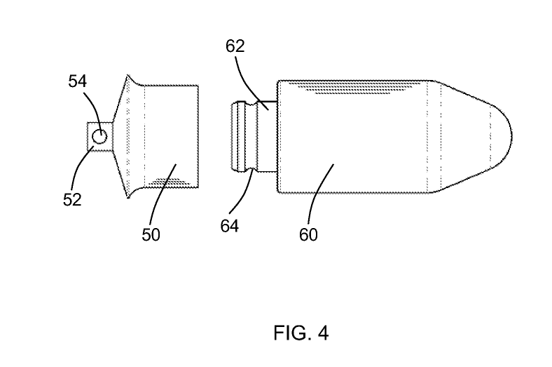

An alternate preferred embodiment of the invention is shown in FIG. 4 in separated position. In this alternate preferred embodiment, the attachment cap 50 shown in FIG. 4 has a female configuration and the weighted body 60 has a male configuration. The weighted body 60 is insertable into the attachment cap 50. The cap 50 preferably has an attachment post 52 and hole 54 for attaching the cap 50 to a fishing line or swivel (not shown.) Preferably, the weighted body 60 has an insertion post 62 with a diameter less than the main portion of the weighted body 60. The insertion post 62 further comprises a perimeter groove 64.

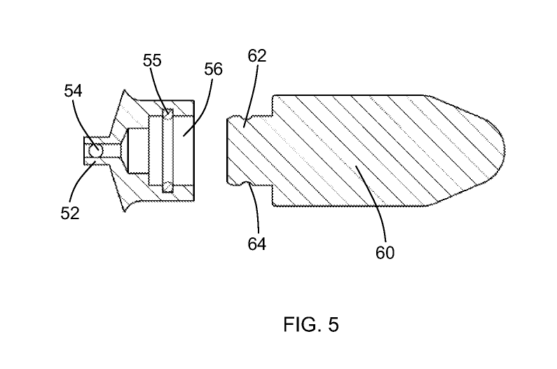

Referring now to FIG. 5, a side cut-away view of the alternate preferred embodiment is shown. The attachment cap 50 preferably further comprises a cavity 56 and a gasket 55. The gasket 55 shown in FIG. 5 is an O-ring. Preferably, the insertion post 62 of the weighted body 60 is inserted into the cavity 56 until the perimeter groove 64 of the body 60 interfaces with the O-ring 55 to hold the weighted body 60 in the cap 50.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A sinker comprising:
an attachment cap inserted into a weighted body and through a gasket.

2. The sinker of claim 1 where the attachment cap further comprises a cavity and an attachment post with a hole.

3. The sinker of claim 1 where the weighted body comprises stainless steel.

4. The sinker of claim 1 where the gasket is an O-ring.

5. The sinker of claim 1 where the attachment cap further comprises a perimeter groove for interface with the gasket.

6. A sinker comprising:
an attachment cap with a perimeter groove, a cavity and an attachment post with a hole inserted into a weighted body through a gasket that interfaces with the perimeter groove.

7. The sinker of claim 6 where the gasket is an O-ring.

8. The sinker of claim 6 where the weighted body comprises stainless steel.

9. The sinker of claim 6 where the attachment cap comprises aluminum.

10. The sinker of claim 6 where the attachment cap is inserted into a dimpled cavity in the weighted body.

11. A sinker comprising:
an attachment cap having a cavity with a gasket where a weighted body is inserted into the cavity through the gasket.

12. The sinker of claim 11 where the weighted body has an insertion post with a perimeter groove to interface with the gasket.

13. The sinker of claim 11 where the gasket is an O-ring.

14. The sinker of claim 12 where the insertion post has a diameter less than the diameter of the weighted body.

15. The sinker of claim 11 where the attachment cap comprises aluminum.

16. The sinker of claim 11 where the weighted body is stainless steel.

17. The sinker of claim 11 where the attachment cap further comprises an attachment post with a hole.
